(19) United States
(12) Patent Application Publication
(10) Pub. No.: US 2006/0241936 A1
(43) Pub. Date: Oct. 26, 2006

(54) Pronunciation specifying apparatus, pronunciation specifying method and recording medium

(75) Inventor: Nobuyuki Katae, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/244,075

(22) Filed: Oct. 6, 2005

(30) Foreign Application Priority Data
Apr. 22, 2005 (JP) 2005-125699

(51) Int. Cl. G06F 17/28

(52) U.S. Cl. 704/6

(57) ABSTRACT

Plural words which partially match the accepted character string data are extracted from a words dictionary. When the numeric character string contained in the accepted character string data has a numeric character string portion for which a partially matching word can not be extracted, a similar word which is similar to the numeric character string portion are extracted from the words dictionary. Based on the extracted words and the extracted similar word, words constituting the accepted character string data are specified, and the pronunciations of the plural extracted words are specified and numerical pronunciation rules are created. The pronunciation of the numeric character string is set in accordance with thus created numerical pronunciation rules. Based on the pronunciations of the specified words and the pronunciation of the similar word including the specified pronunciation of the numeric character string, the pronunciation of the character string data is specified.

### CROSS-REFERENCE TO RELATED APPLICATIONS

This Nonprovisional application claims priority under 35 U.S.C.§119(a) on Patent Application No. 2005-125699 filed in Japan on Apr. 22, 2005, the entire contents of which are hereby incorporated by reference.

### BACKGROUND OF THE INVENTION

The present invention relates to a pronunciation specifying apparatus, a pronunciation specifying method and a recording medium which specify a proper pronunciation for synthesized speech for character string data containing a numeric character string without increasing the memory capacity of a words dictionary.

The recent years have seen increasing popularity of an interactive voice response (IVR) system such as a voice portal which uses an auto speech recognition (ASR) apparatus, a text-to-speech (TTS) apparatus, etc. As an auto speech recognition apparatus recognizes a speech of a user and a text-to-speech apparatus provides a synthesized speech as a response corresponding to the result of recognition, an interactive voice response system interacts with the user.

A character string from which a text-to-speech apparatus creates a synthetic speech often contains a numeric character string. However, while the pronunciation of a numeric character string contained in a character string is specified, various pronunciations may be adopted depending upon the purpose intended by a user. For instance, it is necessary to properly use a style of reading such as: split column reading in which numeric characters forming a numeric character string are pronounced one by one sequentially; column reading in which numeric characters forming a numeric character string are pronounced by adding “billion”, “million”, “thousand” or the like; a style in which “0 (zero)” is pronounced “O” of the alphabet; a style in which two consecutive “0 (zeros)” are pronounced “double-O”; and reading in which three consecutive “0 (zeros)” are pronounced “triple-O”.

For appropriate pronunciation of a numeric character string, Japanese Patent Application Laid-Open No. H8-146984, for instance, discloses a text-to-speech apparatus which stores, as a pronunciation attribute, the style of pronouncing a numeric character string such as split column reading in which numeric characters forming a numeric character string are pronounced one by one sequentially and column reading in which numeric characters forming a numeric character string are pronounced followed by adding “billion”, “million”, “thousand” or the like, for the respective numeric characters forming a numeric character string, and determines which pronunciation style to choose in accordance with the number of the characters to be pronounced and the number of syllables, the length of time for pronunciation, etc.

Japanese Patent Application Laid-Open No. H9-006379 and Japanese Patent Application Laid-Open No. HA-199195 disclose a text-to-speech apparatus which determines, based on selection conditions such as characters preceding a numeric character string, the type of the preceding characters, subsequent characters and the type of the subsequent characters, which style of reading to select, split column reading in which numeric characters forming the numeric character string are pronounced one by one sequentially or column reading in which numeric characters forming a numeric character string are pronounced followed by adding “billion”, “million”, “thousand” or the like.

### BRIEF SUMMARY OF THE INVENTION

The present invention has been made in light of the circumstance above, and aims at providing a pronunciation specifying apparatus, a pronunciation specifying method and a recording medium which specify a proper pronunciation commensurate to a situation surrounding a user even for character string data containing a numeric character string in speech synthesis.

To achieve the object above, the pronunciation specifying apparatus of the first invention includes a words dictionary in which the notations and the pronunciations of plural words are stored, wherein the pronunciation of character string data containing a numeric character string is specified. The apparatus comprises: means which accepts character string data containing a numeric character string; matching word extracting means which extracts, from among the plural words stored in the words dictionary, plural words which partially match the character string data thus accepted; judging means which determines whether the numeric character string contained in the character string data thus accepted has a numeric character string portion for which the matching word extracting means can not extract a partially matching word; similar word extracting means which, when the judging means determines that there is a numeric character string portion for which a partially matching word can not be extracted, extracts from the words dictionary a similar word which is similar to the numeric character string portion for which the extraction is found impossible; word specifying means which specifies words constituting the character string data thus accepted, based on the plural words and the similar words extracted by the matching word extracting means and the similar word extracting means; word pronunciation specifying means which specifies the pronunciations of the plural words extracted by the matching word extracting means from among the words specified by the word specifying means; rule creating means which creates numerical pronunciation rules which are rules regarding the pronunciation of the numeric character string contained in the similar word extracted by the similar word extracting means from among the words specified by the word specifying means; numeric character string pronunciation specifying means which specifies the pronunciation of the numeric character string contained in the similar word, based on the numerical pronunciation rules created by the rule creating means; and character string pronunciation specifying means which specifies the pronunciation of the character string data, based on the pronunciations of the words specified by the word pronunciation specifying means and based on the pronunciation of the similar word including the pronunciation of the numeric character string specified by the numeric character string pronunciation specifying means.

According to the second invention, in the pronunciation specifying apparatus of the first invention, the similar word extracting means calculates similarities which are values of evaluation indicative of the levels of similarity, based on at least one selected from a group of characters preceding a predetermined numeric character string, the types of these characters, the number of these characters, subsequent characters, the types of these characters, the number of these characters, the number of the characters in the numeric character string and the numerical values in the numeric character string, among words stored in the words dictionary, and extracts a word whose calculated similarity is the highest as the similar word.

According to the third invention, in the pronunciation specifying apparatus of the first or the second invention, the rule creating means creates one or plural numerical pronunciation rules containing information regarding distinction between column reading and split column reading, language information and information regarding the pronunciation of each numerical character, based on the pronunciation stored in correlation to the extracted similar word.

According to the fourth invention, the pronunciation specifying apparatus of any one of the first through the third inventions further comprises numerical pronunciation rule storing means which stores, in memory means, the numerical pronunciation rules created by the rule creating means.

According to the fifth invention, the pronunciation specifying apparatus of any one of the first through the fourth inventions further comprises numerical character string pronunciation memory means which stores, in the words dictionary, the notation and the pronunciation of the numeric character string specified by the numeric character string pronunciation specifying means.

The pronunciation specifying apparatus of the sixth invention includes a words dictionary in which the notations and the pronunciations of plural words are stored, wherein the pronunciation of character string data containing a numeric character string is specified. The apparatus comprises a processor capable of performing the operations of accepting character string data containing a numeric character string; extracting plural words which partially match with the character string data thus accepted, from among the plural words stored in the words dictionary; determining whether the numeric character string contained in the character string data thus accepted has a numeric character string portion for which a partially matching words can not be extracted; extracting from the words dictionary a similar word which is similar to the numeric character string portion for which the extraction is found impossible, when it is determined that there is a numeric character string portion for which a partially matching word can not be extracted; specifying words constituting the character string data thus accepted, based on the plural words and the extracted similar word; specifying the pronunciations of the extracted plural words among the specified words; creating numerical pronunciation rules which are rules regarding the pronunciation of the numeric character string contained in the extracted similar word among the specified words; specifying the pronunciation of the numeric character string contained in the similar words, based on the numerical pronunciation rules thus created; and specifying the pronunciation of the character string data, based on the pronunciations of the specified words and based on the pronunciation of the similar word including the pronunciation of the numeric character string thus specified.

According to the seventh invention, the pronunciation specifying apparatus of the sixth invention comprises the processor further capable of performing the operations of calculating similarities which are values of evaluation indicative of the levels of similarity, based on at least one selected from a group of characters preceding a predetermined numeric character string, the types of these characters, the number of these characters, subsequent characters, the types of these characters, the number of these characters, the number of the characters in the numeric character string and the numerical values in the numeric character string, among words stored in the words dictionary; and extracting a word whose calculated similarity is the highest as the similar word.

According to the eighth invention, the pronunciation specifying apparatus of the sixth or the seventh invention comprises the processor further capable of performing the operations of creating one or plural numerical pronunciation rules containing information regarding distinction between column reading and split column reading, language information and information regarding the pronunciation of each numerical character, based on the pronunciation stored in correlation to the extracted similar word.

According to the ninth invention, the pronunciation specifying apparatus of any one of the sixth through the eighth inventions comprises the processor further capable of performing the operations of storing the numerical pronunciation rules thus created, in memory means.

According to the tenth invention, the pronunciation specifying apparatus of any one of the sixth through the ninth inventions comprises the processor further capable of performing the operations of storing the notation and the pronunciation of the numeric character string thus set, in the words dictionary.

The pronunciation specifying method according to the eleventh invention is a pronunciation specifying method of specifying the pronunciation of character string data containing a numeric character string, using a words dictionary in which the notations and the pronunciations of plural words are stored, comprising the steps of accepting character string data containing a numeric character string; extracting plural words which partially match the character string data thus accepted, from among the plural words stored in the words dictionary; determining whether the numeric character string contained in the character string data thus accepted has a numeric character string portion for which a partially matching word can not be extracted; extracting from the words dictionary a similar word which is similar to the numeric character string portion for which the extraction is found impossible, when it is determined that there is a numeric character string portion for which a partially matching word can not be extracted; specifying words constituting the character string data thus accepted, based on the plural words and the extracted similar word; specifying the pronunciations of the extracted plural words among the specified words; creating numerical pronunciation rules which are rules regarding the pronunciations of numeric character strings contained in the extracted similar word among the specified words; specifying the pronunciation of the numeric character strings contained in the similar word, based on the numerical pronunciation rules thus created; and specifying the pronunciation of the character string data, based on the pronunciations of the specified words and based on the pronunciation of the similar word including the pronunciation of the numeric character string thus specified.

The recording medium according to the twelfth invention is a recording medium recording a computer program which makes a computer, which is capable of querying a words dictionary in which the notations and the pronunciations of plural words are stored, function as a reading creation apparatus which specifies the pronunciation of character string data containing a numeric character string. The computer program stored in the recording medium comprises the steps of causing the computer to extract plural words which partially match with the character string data thus accepted, from among the plural words stored in the words dictionary; causing the computer to determine whether the numeric character string contained in the character string data thus accepted has a numeric character string portion for a which partially matching word can not be extracted; causing the computer to extract from the words dictionary a similar word which is similar to the numeric character string portion for which a partially matching words can not be extracted, when it is determined that there is a numeric character string portion for which the extraction is found impossible; causing the computer to specify words constituting the character string data thus accepted, based on the plural words and the extracted similar word; causing the computer to specify the pronunciations of the extracted plural words among the specified words; causing the computer to create numerical pronunciation rules which are rules regarding the pronunciation of the numeric character string contained in the extracted similar word among the specified words; causing the computer to specify the pronunciation of the numeric character string contained in the similar word, based on the numerical pronunciation rules thus created; and causing the computer to specify the pronunciation of the character string data, based on the pronunciations of the specified words and based on the pronunciation of the similar word including the pronunciation of the numeric character string thus specified.

In the recording medium according to the twelfth invention, similarities may be calculated which are values of evaluation indicative of the levels of similarity, based on at least one selected from a group of characters preceding a predetermined numeric character string, the types of these characters, the number of these characters, subsequent characters, the types of these characters, the number of these characters, the number of the characters in the numeric character string and the numerical values in the numeric character string, among words stored in the words dictionary, and a word whose calculated similarity is the highest may be extracted as the similar word.

Further, in the recording medium according to the twelfth invention, one or plural numerical pronunciation rules may be created which contain information regarding distinction between column reading and split column reading, language information and information regarding the pronunciation of each numerical character, based on the pronunciation stored in correlation to the extracted similar word.

Further, in the recording medium according to the twelfth invention, thus created numerical pronunciation rules may be stored in memory means, or the notation and the pronunciation of the numeric character strings thus set may be stored in the words dictionary.

In the first, the sixth, the eleventh and the twelfth inventions, character string data containing a numeric character string is accepted, plural words which partially match the accepted character string data are extracted from the plural words stored in the words dictionary, and whether the numeric character string contained in the accepted character string data has a numeric character string portion for which a partially matching word can not be extracted is determined. When there is a numeric character string portion for which a partially matching word can not be extracted, a similar word which is similar to the numeric character string portion for which the extraction is found impossible are extracted from the words dictionary, and based on the extracted words and the extracted similar word, words constituting the accepted character string data are specified, and the pronunciations of the plural extracted words are specified among the specified words. Numerical pronunciation rules are created which are rules regarding the pronunciation of the numeric character strings contained in the plural similar words, and in accordance with thus created numerical pronunciation rules, the pronunciation of numeric character string contained in the similar words are specified. Based on the pronunciations of the specified words and based on the pronunciations of the similar words including the specified pronunciations of the numeric character string, the pronunciation of the character string data is specified. Hence, even when the numeric character string is not stored in the words dictionary, it is possible to easily specify the pronunciation of the numeric character string which is not stored in the words dictionary based on the pronunciation of the similar numeric character string stored in the words dictionary and to create a synthetic speech which pronounces the numeric character string in the proper pronunciation. Further, since it is not necessary to store selection conditions regarding pronunciations and information regarding the pronunciations, it is possible to shorten the time for selecting a pronunciation without loading upon the computer resources and it is possible to prevent a slowed response in creating and outputting a synthetic speech.

In the second and the seventh inventions, similarities are calculated which are values of evaluation indicative of the levels of similarity, based on at least one selected from a group of characters preceding a predetermined numeric character string, the types of these characters, the number of these characters, subsequent characters, the types of these characters, the number of these characters, the number of the characters in the numeric character string and the numerical values in the numeric character string, among words stored in the words dictionary, and a word whose calculated similarity is the highest is extracted as the similar word. This makes it possible to extract without fail the closest word from the words dictionary based on, for example, information regarding characters preceding the numeric character string and/or characters following the numeric character string, etc., and to specify the pronunciation of the numeric character string in line with the pronunciation of the extracted word.

In the third and the eighth invention, one or plural numerical pronunciation rules are created which contain information regarding distinction between column reading and split column reading, language information and information regarding the pronunciation of each numerical character, based on the pronunciation stored in correlation to the extracted similar word. This makes it possible to easily apply the numerical pronunciation rules created from the extracted similar word to the numeric character string contained in the accepted character string, and to create a synthesized speech which uses the pronunciation of the numeric characters which are suitable to the purpose intended by a user.

In the fourth and the ninth inventions, the created numerical pronunciation rules are stored in the memory means. This makes it possible to specify the pronunciation of the numeric character string more accurately when character string data containing a numeric character string of the same type is accepted the next and subsequent times, and hence to improve a response for creation of a synthetic speech.

In the fifth and the tenth inventions, the notation and the pronunciation of the specified numeric character string in the words dictionary. This makes it possible to use the words stored in the words dictionary when character string data containing a numeric character string of the same type is accepted the next and subsequent times and particularly when the numeric character string is all or part of a proper noun, and since it is not necessary to extract a similar words, it is possible to create a synthesized speech which uses an appropriate pronunciation more accurately in a faster response.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram which shows the structure of a text-to-speech apparatus according to a first embodiment of the present invention;

FIGS. 2A and 2B are flow charts which show the sequence of processing performed by a CPU of the text-to-speech apparatus according to the first embodiment of the present invention;

FIG. 3 is a drawing which shows one example of a data structure in a basic words dictionary and a user's words dictionary,

FIG. 4 is a drawing which shows a group of words extracted from the basic words dictionary and the user's words dictionary based on character string data accepted by the CPU of the text-to-speech apparatus;

FIG. 5 is a drawing which shows similar words extracted based on a numeric character string;

FIG. 6 is a drawing which shows the result of specifying of words;

FIG. 7 is a drawing which shows the result of specification of the pronunciation of character string data as a whole, including a numeric character string portion;

FIG. 8 is a block diagram which shows the structure of the text-to-speech apparatus according to the first embodiment as it is equipped with a temporary words dictionary;

FIG. 9 is a block diagram which shows the structure of a text-to-speech apparatus according to a second embodiment of the present invention;

FIG. 10 is a drawing which shows one example of a data structure stored in a numerical pronunciation rules storage part;

FIG. 11 is a flow chart which shows the sequence of processing performed by a CPU of the text-to-speech apparatus according to the second embodiment of the present invention;

FIG. 12 is a drawing which shows the result of specification of words;

FIG. 13 is a drawing which shows the result of specification Of the pronunciation of character string data as a whole, including a numeric character string portion; and

FIG. 14 is a drawing which shows one example of a data structure stored in the numerical pronunciation rules storage part in which levels of importance are assigned.

### DETAILED DESCRIPTION OF THE INVENTION

Japanese Patent Application Laid-Open No. H8-146984 described above requires selecting either one of split column reading in which numeric characters forming a numeric character string are pronounced one by one sequentially and column reading in which numeric characters forming a numeric character string are pronounced by adding “billion”, “million”, “thousand” or the like. However, it is not possible to properly use a style of reading such as a style in which “0 (zero)” is pronounced “O” of the alphabet, a style in which two consecutive “0 (zeros)” are pronounced “double-O” and a style in which three consecutive “0 (zeros)” are pronounced “triple-O”, etc. This could result in creation of a synthetic speech in wrong pronunciation in the case of a proper noun in particular such as the name of a product and the name of a service. Depending upon the pronunciation style, there is a problem that a user can not recognize a product, a service or the like and can not continue on interaction based on speech.

Meanwhile, according to Japanese Patent Application Laid-Open No. H9-006379 and Japanese Patent Application Laid-Open No. H4-199195, a great number of selection conditions are set and it is therefore possible to use not only split column reading in which numeric characters forming a numeric character string are pronounced one by one sequentially and column reading in which numeric characters forming a numeric character string are pronounced followed by adding “billion”, “million”, “thousand” or the like, but also a reading style in which “0 (zero)” is pronounced “O” of the alphabet, reading in which two consecutive “0 (zeros)” are pronounced “double-O” and reading style in which three consecutive “0 (zeros)” are pronounced “triple-O”, etc. It is nevertheless necessary to set a great number of selection conditions for each application to implement, which setting is complicated to a user. Depending upon a selection condition, plural pronunciation styles may be selected. In this case, a problem arises that there is no criteria regarding which one of the pronunciation styles should be given a higher priority.

Further, with memory means storing all the selection conditions related to numeric character strings, pronunciation styles for all numeric character strings and the like, it is possible to pronounce the numeric character strings in any circumstance. However, the memory means has a limited physical memory capacity, which leads to a problem that storing the pronunciation styles for all numeric character strings in advance accompanies a slowed search response and thus is not practical or feasible.

The present invention has been made in light of the above, and aims at providing a pronunciation specifying apparatus, a pronunciation specifying method and a recording medium with which it is possible to create synthetic speech using proper pronunciations in accordance with the situation surrounding a user even for character string data containing a numeric character string, and is realized as embodiments below. As the embodiments, application of a pronunciation specifying apparatus according to the present invention to a text-to-speech apparatus will be described.

### FIRST EMBODIMENT

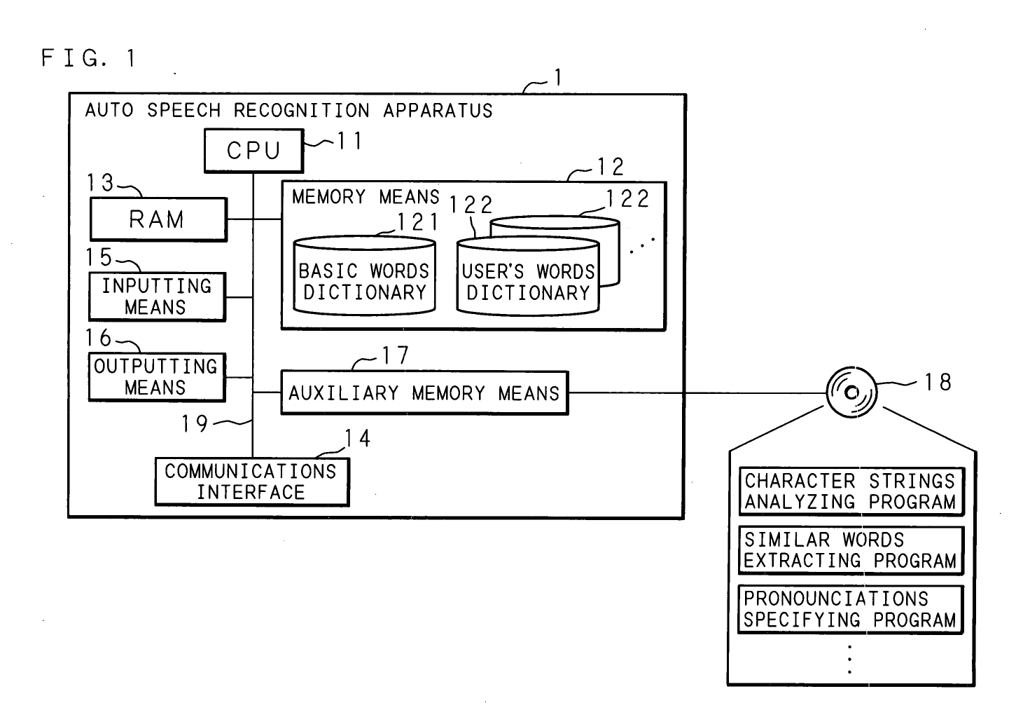

A text-to-speech apparatus using a pronunciation specifying apparatus according to the first embodiment of the present invention will now be described with reference to the associated drawings. FIG. 1 is a block diagram which shows the structure of the text-to-speech apparatus according to the first embodiment of the present invention. As shown in FIG. 1, the text-to-speech apparatus 1 is comprised at least of a CPU (central processing unit) 11, memory means 12, a RAM 13, a communications interface 14 for connection with external communications means, inputting means 15, outputting means 16 and auxiliary memory means 17 which uses a portable storage medium 18 such as a DVD and a CD.

The CPU 11 is connected with the respective hardware portions of the text-to-speech apparatus 1 mentioned above via an internal bus 19, controls the respective hardware portions above, and executes various types of software-like functions in accordance with processing programs stored in the memory means 12 which may be for example a program for analyzing a character string which contains a numeric character string, a program which queries a words dictionary, a program which extracts a similar word, a program which specifies a pronunciation in accordance with rules regarding the pronunciations of similar words, and the like.

The memory means 12 stores processing programs which are necessary for the text-to-speech apparatus 1 to serve its functions and which are acquired from an external computer formed by a built-in fixed storage device (hard disk), ROM or the like via the communications interface 14 or from the portable storage medium 18 such as a DVD and a CD-ROM. Not only the processing programs, the memory means 12 also stores a basic words dictionary 121 which is a general-purpose words dictionary and user's words dictionaries 122, 122, . . . which are words dictionaries of respective users as words dictionaries storing the notations, the pronunciations, parts of speech and the like of words which are for creating synthetic speech.

The RAM 13 is formed by a DRAM, etc., and stores temporary data which are generated at the time of execution of software. The communications interface 14 is connected with the internal bus 19, and connection with an external network for communications realizes receipt and transmission of data which are necessary for processing.

The inputting means 15 is a key board which accepts entry of a character string which contains a numeric character string which needs be pronounced. The inputting means 15 is not limited to a key board but may instead be an other inputting medium which permits inputting of a character string. The outputting means 16 is a speaker which outputs a synthetic speech created using specified pronunciations.

The auxiliary memory means 17 downloads to the memory means 12 a program, data or the like to be processed by the CPU 11, using the portable storage medium 18 such as a DVD and a CD. It is also possible to write data processed by the CPU 11 to create a back-up.

While an example that the text-to-speech apparatus 1, the inputting means 15 and the outputting means 16 are integrated is described as the first embodiment, the construction is not limited to this in any particular sense: One text-to-speech apparatus 1 may be connected with an external inputting device or outputting device.

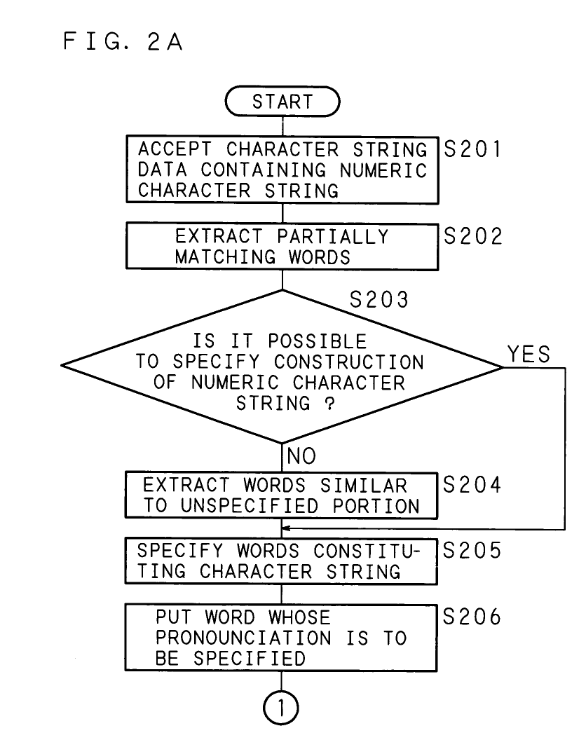

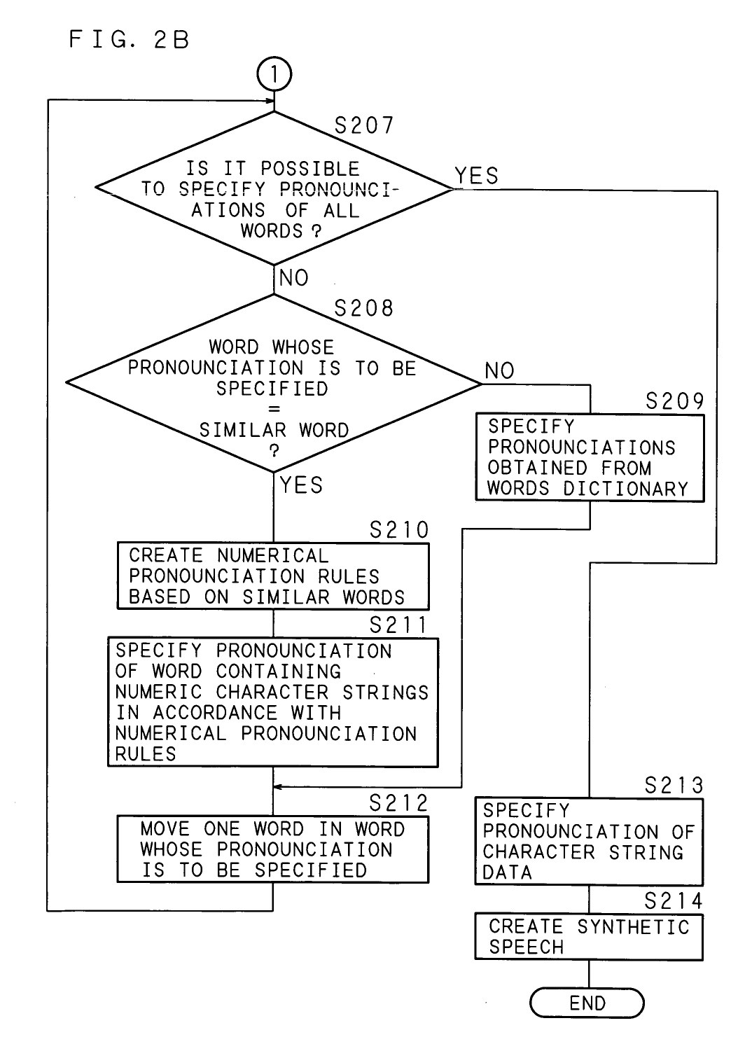

An operation of the text-to-speech apparatus 1 above will now be described in relation to an example of outputting synthetic speech which reads, “M901i was placed on sale today,” where “F900i” is stored but “M901i” is not stored in the basic words dictionary 121 or the user's words dictionaries 122, 122, . . . FIGS. 2A and 2B are flow charts which show the sequence of processing performed by the CPU 11 of the text-to-speech apparatus 1 according to the first embodiment of the present invention.

Via the inputting means 15, the CPU 11 of the text-to-speech apparatus 1 accepts character string data which reads, “M901i was placed on sale today” and contains a numeric character string “901” (Step S201). Querying the basic words dictionary 121 and the user's words dictionary 122, the CPU 11 extracts words which partially match the accepted character string data (Step S202). The user's words dictionaries 122 are stored in correlation to identification information (which may be user IDs for instance), i.e., information which identifies users, and are selected based on log-in information of the users.

When combinations of the plural words extracted as partially matching words can not specify the construction which is not the numeric character string, since it is not possible to pronounce the character string, error processing need be performed in which an error message is output and re-inputting is encouraged, etc. FIGS. 2A and 2B, however, omit a description related to the error processing, assuming that the pronunciation of the portion which is not the numeric character string is specified.

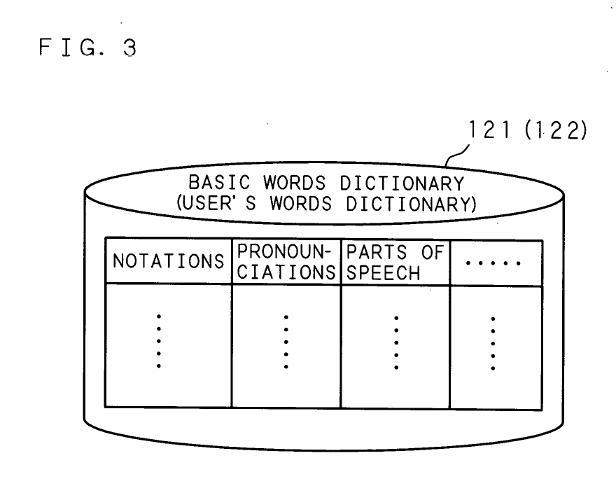

FIG. 3 is a drawing which shows one example of a data structure in the basic words dictionary 121 and the user's words dictionaries 122, 122, . . . As shown in FIG. 3, the basic words dictionary 121 and the user's words dictionaries 122, 122, . . . store at least the pronunciation and part of speech for each notation of a word. For each word contained in character string data, the pronunciation and part of speech are extracted using the notation of the word as key information.

The CPU 11 determines whether combinations of plural partially matching words can specify the construction of the numeric character string contained in the character string data (Step S203). When the CPU 11 determines that it is possible to specify the construction of the numeric character string contained in the character string data (YES at Step S203), the CPU 11 skips to Step S205.

When the CPU 11 determines that it is not possible to specify the construction of the numeric character string contained in the character string data (NO at Step S203), the CPU 11 extracts, from the basic words dictionary 121 and the user's words dictionary 122, a similar word which is similar to the portion in which the construction of the numeric character string is not specified by the partially matching words (Step S204).

For the purpose of extracting a similar word, out of the words stored in the words dictionaries, the CPU 11 first calculates similarities which are values of evaluation indicative of the levels of similarity, based on at least one selected from a group of characters preceding the numeric character string whose construction is not specified, the types of these characters, the number of these characters, subsequent characters, the types of these characters, the number of these characters, the number of the characters in the numeric character string and the numerical values in the numeric character string. The method of calculating similarities is not limited to any particular method: For example, calculation may be performed based on (Eq. 1). In (Eq. 1), the character type means the character classification such as alphabet, Greek, Russian, hiragana, katakana, Chinese character, and symbols.
Similarity=the number of preceding matching characters×100+the number of matching character types in the preceding characters+the number of subsequent matching characters×100+the number of matching character types in the subsequent characters−the difference in the number of the characters in the numeric character string−the difference in the numerical value expressed by the numeric character string (Eq. 1)

For instance, calculation is made using (Eq. 1) on a similarity to the numeric character string “901” contained in the character string data which reads, “M901i was placed on sale today” where “F900i” is stored in the user's words dictionary 122. In this case, since the number of preceding matching characters=0, the number of matching character types in the preceding characters=1, the number of subsequent matching characters=1, the number of matching character types in the subsequent characters=1, the difference in the number of the characters in the numeric character string=0 and the difference in the numerical value expressed by the numeric character string=1, the similarity is calculated as “101.”

Based on the calculated similarities, a word having the maximum similarity for example are extracted as a similar word. Of course, the method is not limited to the extraction of words having the maximum similarity: Plural candidate words may be extracted in the order of higher similarities to be subjected to be a selection by a user, or alternatively, words beyond a predetermined threshold value (threshold value=100 for example) may be extracted as candidate words.

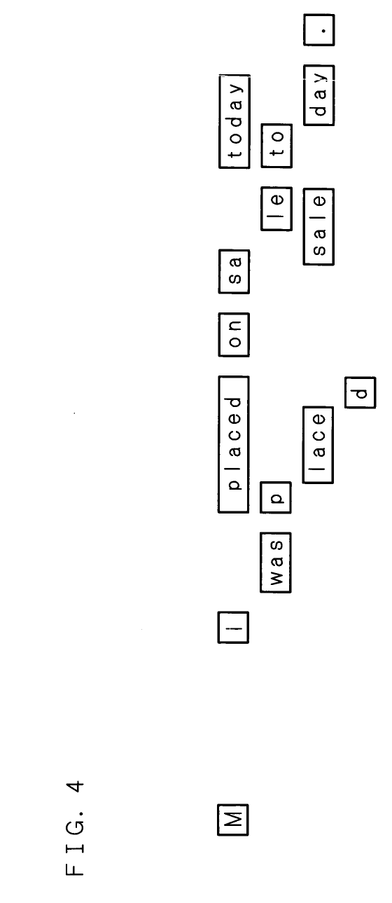

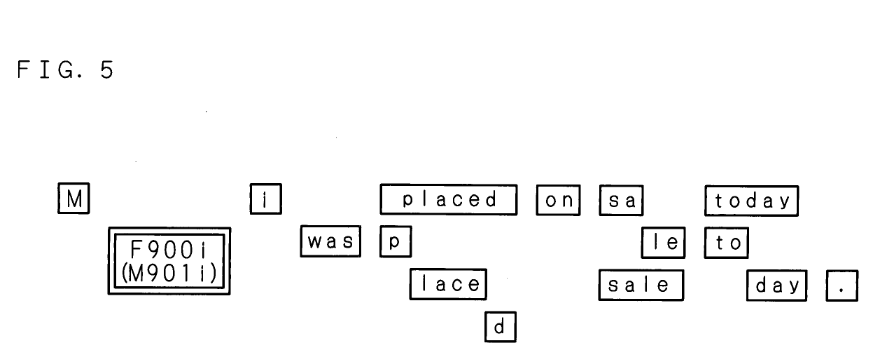

FIG. 4 is a drawing which shows a group of words extracted from the basic words dictionary 121 and the user's words dictionary 122 based on the character string data accepted by the CPU 11 of the text-to-speech apparatus 1, and FIG. 5 is a drawing which shows the result of additional extraction of similar words as for the numeric character string. In FIGS. 4 and 5, each word in a box is one word extracted from the basic words dictionary 121 or the user's words dictionary 122. In FIG. 5, the word in the double-line box is a similar word containing a numeric character string extracted from the basic words dictionary 121 or the user's words dictionary 122.

As shown in FIG. 4, numeric character strings are rarely stored in the basic words dictionary 121 or the user's words dictionaries 122, except for when they are special proper nouns. Even in the example in FIG. 4, the numeric character string “901” is not stored.

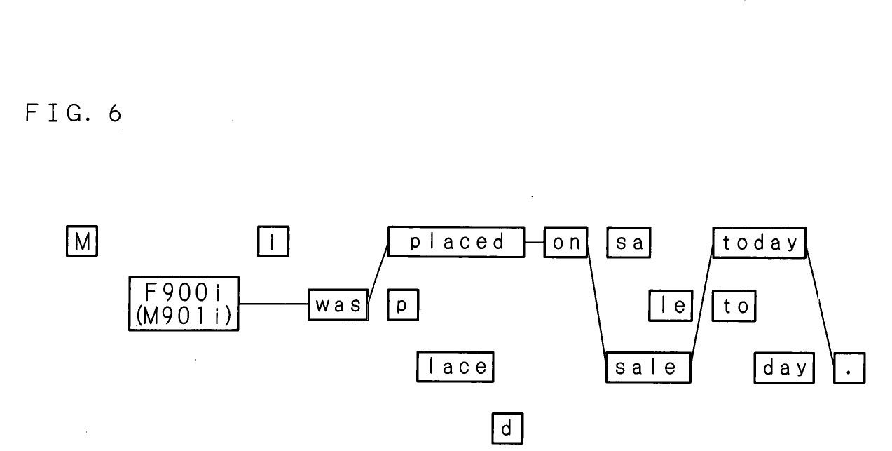

The CPU 11 specifies the words constituting the accepted character string data, from the extracted plural words (Step S205). The method of specifying the words is not limited to any particular method: For example, the words may be specified based on multiple criteria such as prioritizing words which can be easily connected with other words, prioritizing long words, etc. FIG. 6 is a drawing which shows the result of specification of the words. In FIG. 6, the words enclosed by the thick solid lines are those words specified as the words constituting the character string data.

The CPU 11 then specifies the pronunciation of each one of the specified words. To be specific, the CPU 11 puts the words whose pronunciations need be specified at the front of the specified words (Step S206), and determines whether the pronunciations of all the words are specified (Step S207). When the CPU 11 determines that there is a word whose pronunciation is not specified (NO at Step S207), the CPU 11 determines whether the word whose pronunciation need be specified is the same as the extracted similar word (Step S208).

When the CPU 11 determines that the word whose pronunciations need be specified is not the same as the extracted similar word (NO at Step S208), the CPU 11 sets the pronunciation of the word extracted from the words dictionaries to the word whose pronunciation need be specified (Step S209). When the CPU 11 determines that the word whose pronunciation need be specified are the same as the extracted similar word (YES at Step S208), the CPU 11 must specify a pronunciation which corresponds to the accepted character string based on the similar word. For instance, where “F900i” is extracted as a similar word to “M901i” based on the relationship between the preceding and the subsequent characters “F” and “i” of the numeric character string in the similar word and the preceding and the subsequent characters “M” and “i” of the numeric character string “M901i”, the pronunciation of the numeric character string “901” is specified.

In other words, based on the extracted similar word, the CPU 11 creates numerical pronunciation rules which are rules regarding the pronunciation of the numeric character string contained in the character string data (Step S210). In accordance with the created numerical pronunciation rules, the CPU 11 specifies the pronunciation of the word containing the numeric character string whose pronunciation is not specified (Step S211).

Numerical pronunciation rules are formed at least by information for identifying the rules and information regarding characters preceding a numeric character string, characters subsequent to the numeric character string, numerical values and pronunciation styles. For example, from the similar word “F901i” shown in FIG. 6, numerical pronunciation rules are created such as split column reading in which numeric characters forming a numeric character string are pronounced one by one sequentially and a style of reading in which “0 (zero)” is pronounced “O” of the alphabet. Numerical pronunciation rules are not limited to these, but may be information regarding distinction between split column reading in which numeric characters forming a numeric character string are pronounced one by one sequentially and column reading in which the numeric characters forming a numeric character string are pronounced followed by adding “billion”, “million”, “thousand” and the like, information regarding distinction in pronunciation of two consecutive “0 (zeros)”, “double-O” or “O-O”, etc.

In accordance with the numerical pronunciation rules created from the similar word. “F900i”, the pronunciation of “M901i” is specified. The pronunciation is therefore specified as “M-nine-O-one-I” as in the case of pronouncing the similar word “F900i” as “F-nine-O-O-I”.

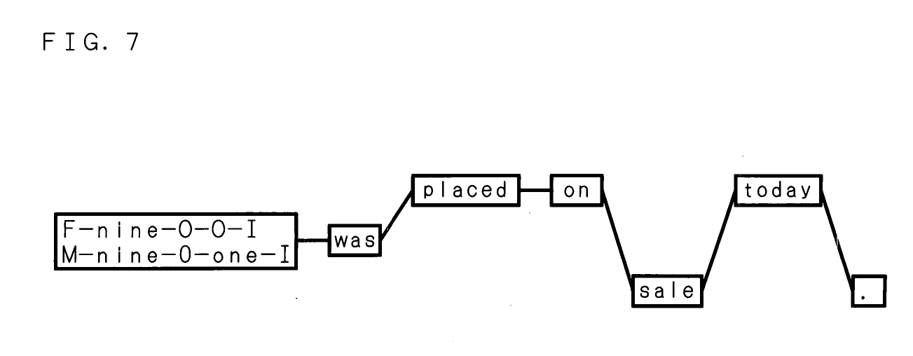

Proceeding one word in the words whose pronunciations need be specified (Step S212), the CPU 11 returns to Step S207. When the CPU 11 determines that the pronunciations of all the words are specified (YES at Step S207), the CPU 11 connects the pronunciations of the specified plural words in the order of notations and specifies the pronunciation of the character string data (Step S213). FIG. 7 is a drawing which shows the result of specification of the pronunciation of the character string data as a whole, including the numeric character string portion. As shown in FIG. 7, the pronunciation of the character string data is therefore “M-nine-O-one-I was placed on sale today”. The CPU 11 creates a synthetic speech based on the specified pronunciation of the character string data (Step S214), and the outputting means 16 outputs the synthetic speech.

As described above, according to the first embodiment, even when a numeric character string is not stored in the basic words dictionary 121 or the user's words dictionaries 122, it is possible to easily specify the pronunciation of the numeric character string which is not stored in the basic words dictionary 121 or the user's words dictionaries 122 based on the pronunciation of a similar numeric character string stored in the basic words dictionary 121 or the user's words dictionaries 122 and to create a synthetic speech which pronounces the numeric character string in the proper pronunciation. Further, since it is not necessary to store selection conditions regarding pronunciation styles and pronunciation style information as for all numeric character strings, it is possible to shorten the time for selecting a pronunciation style without loading upon the computer resources and it is possible to prevent a slowed response in creating and outputting a synthetic speech.

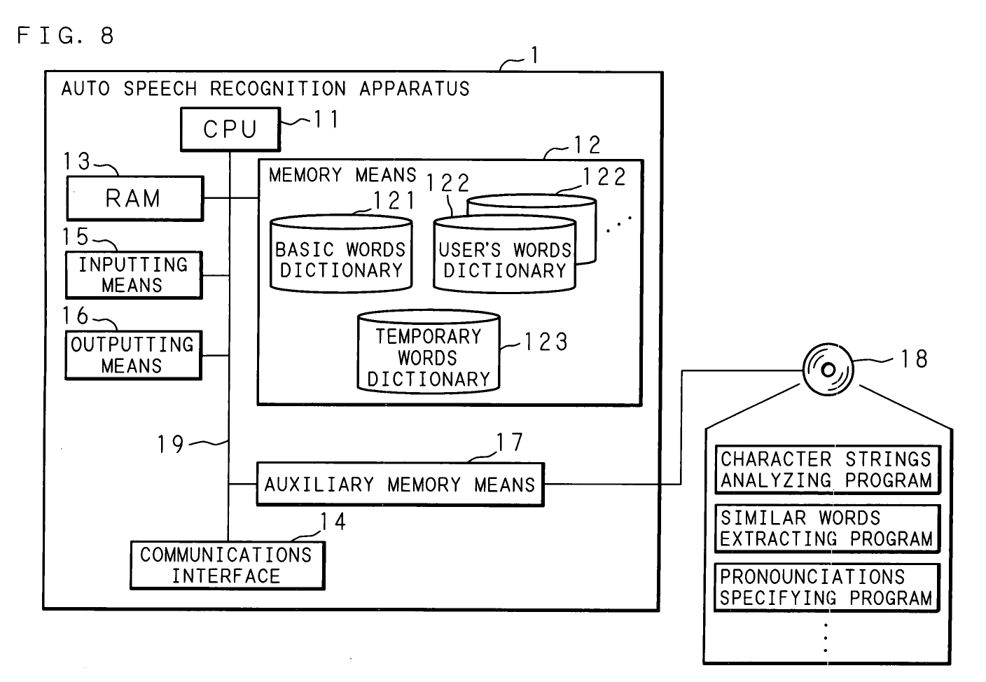

While the embodiment described above requires calculating similarities, which are needed to identify a similar words, every time character string data is accepted and the accepted character string data is found to contain a numeric character string, the memory means 12 may include a temporary words dictionary 123 which temporarily stores the notation of similar word, specified pronunciation, part of speech and the like, for the purpose of reducing a load upon computation which is thus executed every time. FIG. 8 is a block diagram which shows the structure of the text-to-speech apparatus 1 according to the first embodiment as it is equipped with the temporary words dictionary 123.

As shown in FIG. 8, in the event that the memory means 12 includes the temporary words dictionary 123, upon acceptance of character string data from a user, the temporary words dictionary is also queried in addition to the basic words dictionary 121 and the user's words dictionaries 122. Additional querying of the temporary words dictionary 123 improves the probability of detecting matching words and reduces the frequency of calculating similarities, and therefore, it is possible to reduce a load upon computation.

### SECOND EMBODIMENT

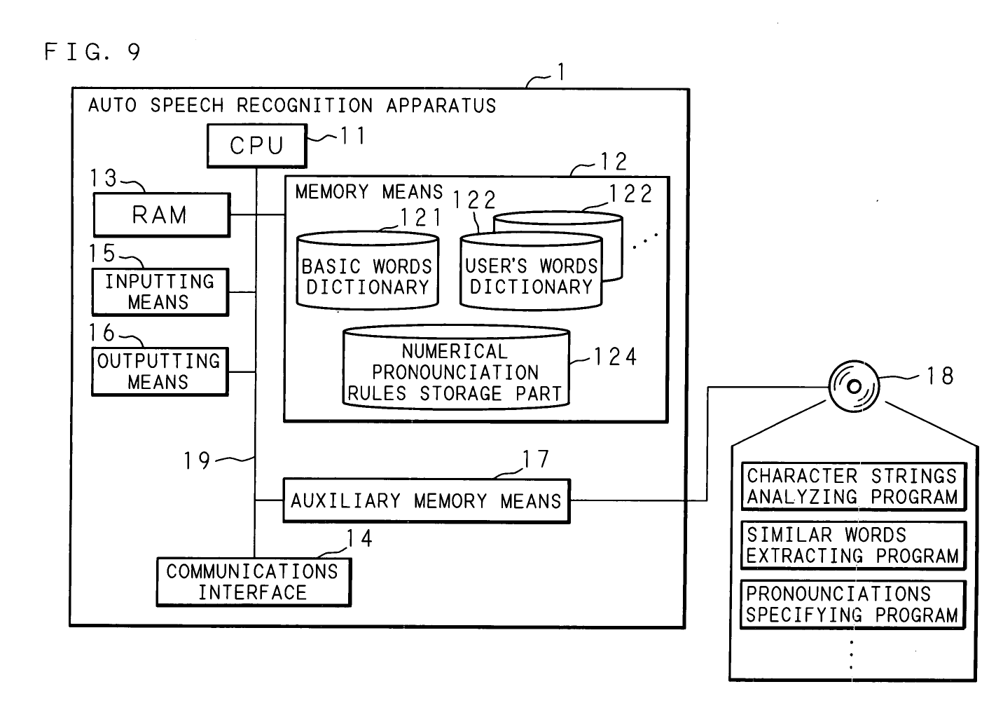

A text-to-speech apparatus according to the second embodiment of the present invention will now be specifically described with reference to the associated drawings. FIG. 9 is a block diagram which shows the structure of the text-to-speech apparatus according to the second embodiment of the present invention. Since the text-to-speech apparatus 1 according to the second embodiment of the present invention has the same basic structure as the first embodiment, structures having the same functions will be denoted by the same reference symbols but will not be described in detail. The second embodiment is characterized in that the memory means 12 comprises a numerical pronunciation rules storage part 124 which stores rules regarding numerical pronunciation styles. In other words, numerical pronunciation rules are created based on words containing numeric character strings stored in the basic words dictionary 121 and the user's words dictionaries 122, 122, . . . , and stored in the numerical pronunciation rules storage part 124.

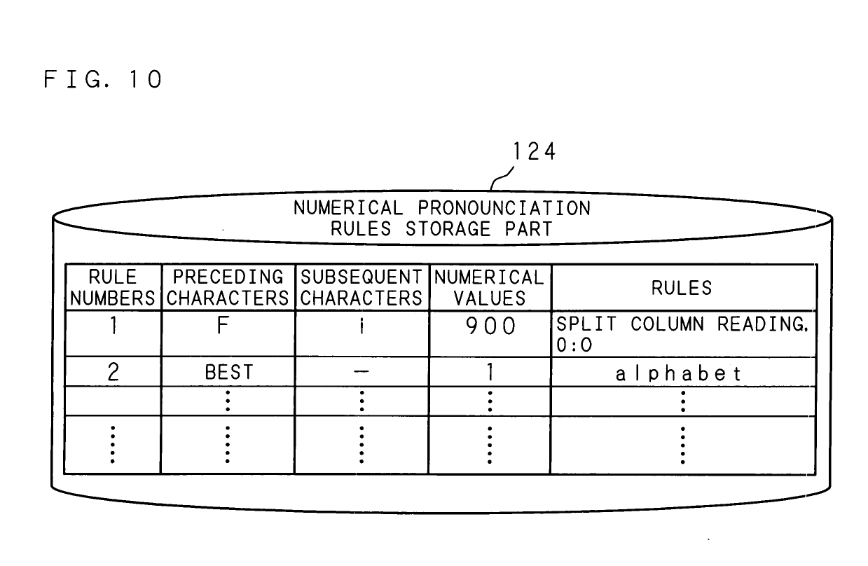

FIG. 10 is a drawing which shows one example of a data structure stored in the numerical pronunciation rules storage part 124. As shown in FIG. 10, the numerical pronunciation rules storage part 124 stores preceding words, subsequent words, numerical values, pronunciation rules and the like in correlation to information for identifying the rules, which may be rule numbers for example. In the case of creating a numerical pronunciation rule based on “F900i”, created and stored in the numerical pronunciation rules storage part 124 is, for example, a pronunciation rule bearing the rule number “1” and requiring split column reading, in which numeric characters forming a numeric character string are pronounced one by one sequentially, and pronouncing “0 (zero)” as “O” of the alphabet.

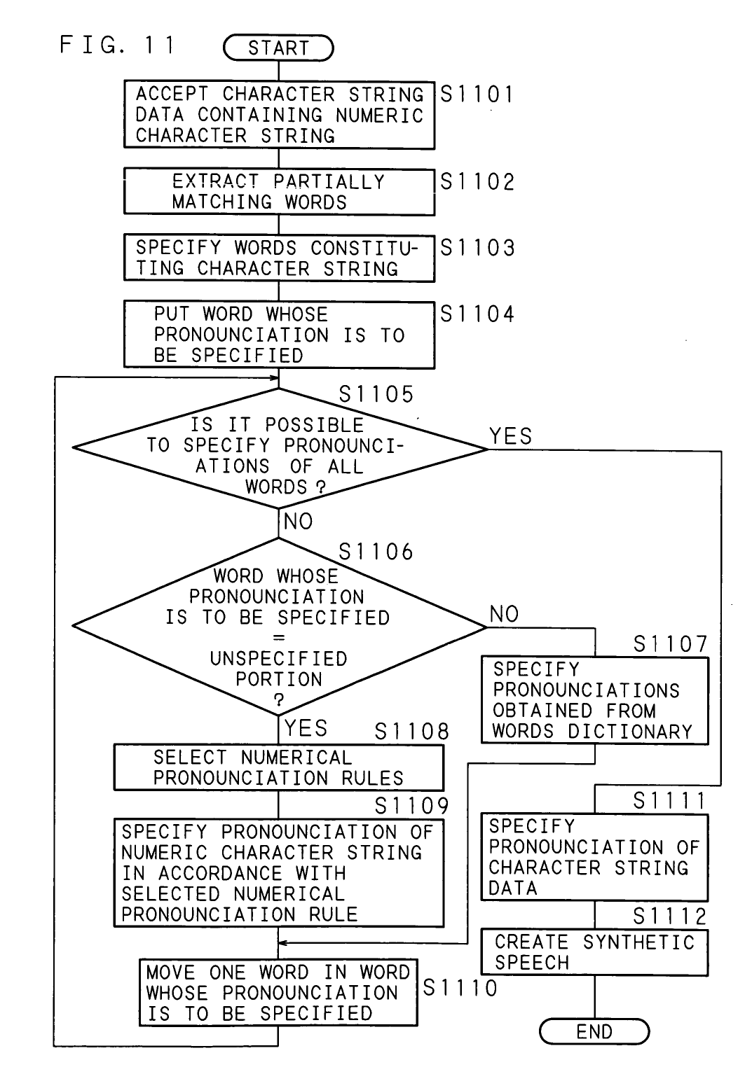

An operation of the text-to-speech apparatus 1 above will now be described in relation to an example of outputting a synthetic speech which reads, “M901i was placed on sale today,” where “F900i” is stored but “M901i” is not stored in the basic words dictionary 121 or the user's words dictionaries 122, 122, . . . FIG. 11 is a flow chart which shows the sequence of processing performed by the CPU 11 of the text-to-speech apparatus 1 according to the second embodiment of the present invention.

Via the inputting means 15, the CPU 11 of the text-to-speech apparatus 1 accepts character string data which reads, “M901i was placed on sale today” and contains the numeric character string “901” (Step S1101). Querying the basic words dictionary 121 and the user's words dictionary 122, the CPU 11 extracts words which partially match the accepted character string data (Step S1102).

When combinations of the plural words extracted as partially matching words can not specify the construction which is not the numeric character string, since it is not possible to pronounce the character string, error processing need be performed in which an error message is output and re-inputting is encouraged, etc. FIG. 11, however, omits a description related to the error processing, assuming that the pronunciation of the portion which is not the numeric character string is specified.

The CPU 11 specifies the words constituting the accepted character string data, from thus extracted plural words (Step S1103). The method of specifying the words is not limited to any particular method: For example, the words may be specified based on multiple criteria such as prioritizing words which can be easily connected with other words, prioritizing long words, etc.

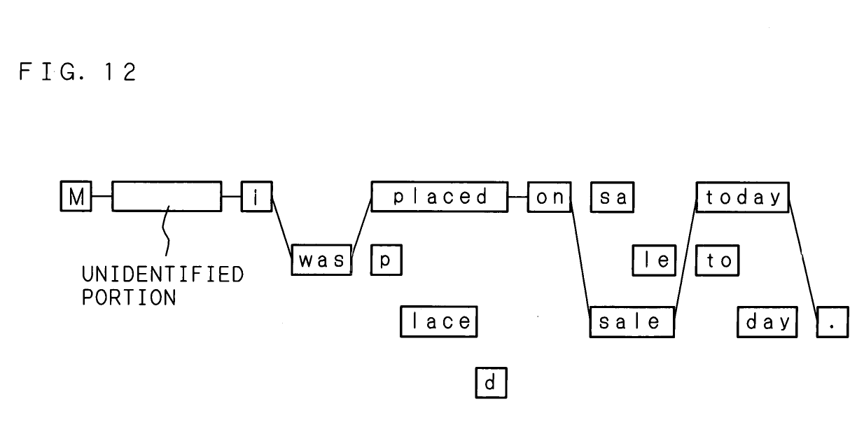

When there still is a portion in which the extracted plural words can not specify the pronunciation of the numeric character string, this portion is viewed as an unspecified-word portion and the words in the other portion are specified. FIG. 12 is a drawing which shows the result of specification of words. In FIG. 12, the words enclosed by the thick solid lines are those words specified as the words constituting the character string data, and the numerical portion, namely the “901” portion is the unspecified-word portion.

The CPU 11 then specifies the pronunciation of each specified word. To be more specific, the CPU 11 treats even the unspecified-word portion as one word and puts the words whose pronunciations need be specified at the front of the specified words (Step S1104), and determines whether the pronunciations of all the words are specified (Step S1105). When the CPU 11 determines that there is a word whose pronunciation is not specified (NO at Step S1105), the CPU 11 determines whether the word whose pronunciation need be specified is the unspecified-word portion (Step S1106).

When the CPU 11 determines that the word whose pronunciation need be specified is not the unspecified-word portion (NO at Step S1106), the CPU 11 sets the pronunciation of a word extracted from the words dictionaries to the word whose pronunciation needs be specified (Step S1107). When the CPU 11 determines that the word whose pronunciation need be specified is the unspecified-word portion (YES at Step S1106), the CPU 11 must specify the pronunciation in accordance with the stored numerical pronunciation rules.

In other words, the CPU 11 calculates indicator values similar to similarities which are used in the first embodiment for instance and accordingly choose an optimal rule from among the plural numerical pronunciation rules stored in the numerical pronunciation rules storage part 124 (Step S1108). The CPU 11 then specifies the pronunciation of the numeric character string in the unspecified-word portion based on the selected numerical pronunciation rule (Step S1109).

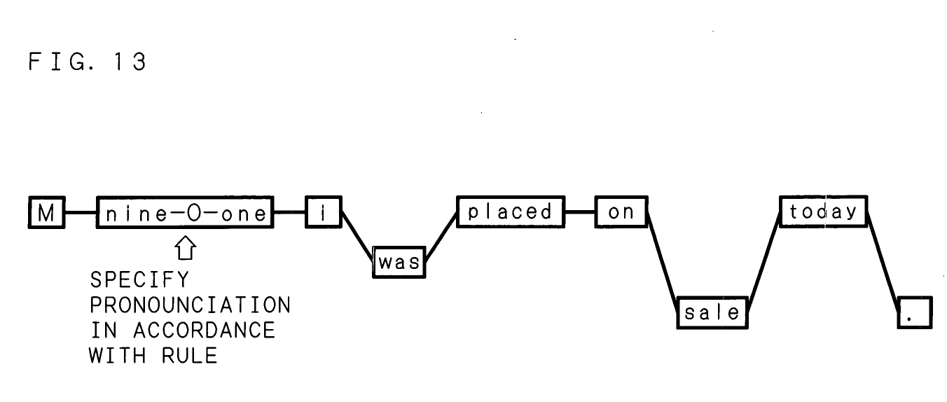

Proceeding one word in the words whose pronunciations need be specified (Step S1110), the CPU 11 returns to Step S1105. When the CPU 11 determines that the pronunciations of all the words are specified (YES at Step S1105), the CPU 11 connects the pronunciations of the plural words thus set in the order of notations and specifies the pronunciation of the character string data (Step S1111). FIG. 13 is a drawing which shows the result of specifying a pronunciation of character string data as a whole, including a numeric character string portion. As shown in FIG. 13, the pronunciation of the character string data is therefore “M-nine-O-one-I was placed on sale today”. The CPU 11 creates a synthetic speech based on the specified pronunciation of the character string data (Step S1112), and the outputting means 16 outputs the synthetic speech.

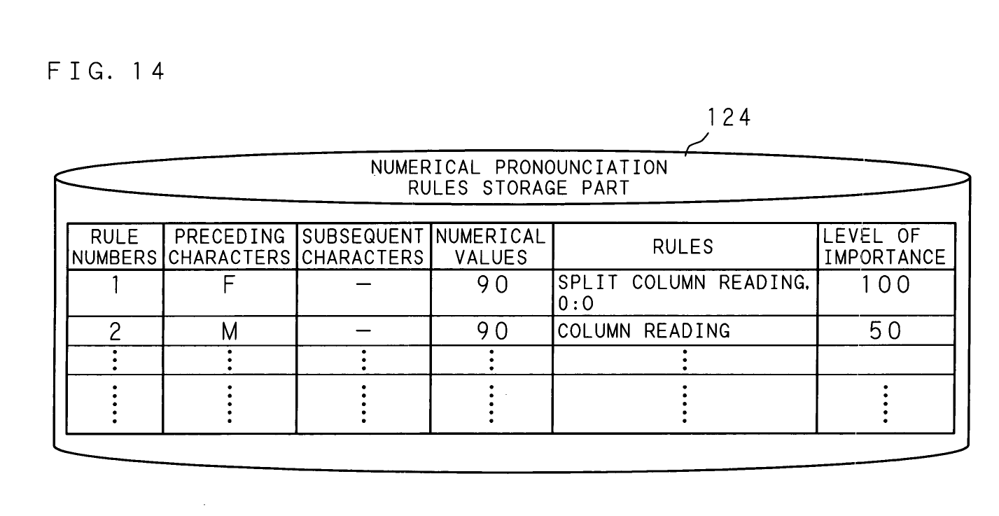

A method of selecting a numerical pronunciation rule is not limited to the selection method based on calculation of the indicator values above: For instance, a level of importance may be assigned to each rule number in accordance with the frequencies at which words appear, and a numerical pronunciation rule may be selected depending upon the assigned level. FIG. 14 is a drawing which shows one example of a data structure stored in the numerical pronunciation rules storage part 124 in which the levels of importance are assigned.

As shown in FIG. 14, the numerical pronunciation rules storage part 124 stores the level of importance to each rule number. A rating is, for instance, an accumulated value of the number of times a numerical pronunciation rule has been used, and the value of importance level is incremented for every extraction of a pronunciation rule for numerical values. In selection of a numerical pronunciation rule, rule numbers are selected in the order of higher level of importance.

As described above, according to the second embodiment, even when the numeric character string is not stored in the basic words dictionary 121 or the user's words dictionaries 122, it is possible to easily specify the pronunciation of the numeric character string which is not stored in the basic words dictionary 121 or the user's words dictionaries 122 based on the rules stored in the numerical pronunciation rules storage part 124 and to create a synthetic speech which pronounces the numeric character string in the proper pronunciation. Further, since it is not necessary to store select conditions regarding pronunciation styles and pronunciation style information for all the numeric character strings, it is possible to shorten the time for selecting a pronunciation style without loading upon the computer resources and it is possible to prevent a slowed response in creating and outputting synthetic speech.

In combination with the first embodiment, the numerical pronunciation rules created based on the similar words may be stored in the numerical pronunciation rules storage part 124 of the memory means 12. When character string data containing a numeric character string of the same type are accepted the next and subsequent times therefore, it is possible to apply an optimal numerical pronunciation rule through querying of the numerical pronunciation rules storage part 124 without extracting similar words, and therefore, to improve a response up to creation of a synthetic speech.

Further, the notation and the pronunciation of the numeric character string set according to the first and the second embodiments described above may be stored in the user's words dictionaries 122. When character string data containing a numeric character string of the same type are accepted the next and subsequent times therefore and particularly when the numeric character string is all or some part of a proper noun, it is possible to specify the pronunciation of the numeric character string based on the numeric character strings stored in the user's words dictionaries 122, and hence, to create a synthetic speech more accurately and in a faster response.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A pronunciation specifying apparatus which includes a words dictionary in which the notations and the pronunciations of plural words are stored, wherein the pronunciation of character string data containing a numeric character string is specified, comprising:
means which accepts character string data containing a numeric character string;
matching word extracting means which extracts, from among the plural words stored in said words dictionary, plural words which partially match said character string data thus accepted;
judging means which determines whether said numeric character string contained in said character string data thus accepted has a numeric character string portion for which said matching word extracting means can not extract a partially matching word;
similar word extracting means which, when said judging means determines that there is a numeric character string portion for which a partially matching word can not be extracted, extracts from said words dictionary a similar word which is similar to said numeric character string portion for which extraction of a partial matching word is found impossible;
word specifying means which specifies words constituting said character string data thus accepted, based on the plural words and the similar word extracted by said matching word extracting means and said similar word extracting means;
word pronunciation specifying means which specifies the pronunciations of the plural words extracted by said matching word extracting means from among the words specified by said word specifying means;
rule creating means which creates numerical pronunciation rules which are rules regarding the pronunciation of the numeric character string contained in the similar word extracted by said similar word extracting means from among the words specified by said word specifying means;
numeric character string pronunciation specifying means which specifies the pronunciation of said numeric character string contained in the similar word, based on said numerical pronunciation rules created by said rule creating means; and
character string pronunciation specifying means which specifies the pronunciation of said character string data, based on the pronunciations of the words specified by said word pronunciation specifying means and based on the pronunciation of the similar word including the pronunciation of said numeric character string specified by said numeric character string pronunciation specifying means.

2. The pronunciation specifying apparatus of claim 1, wherein said similar word extracting means calculates similarities which are values of evaluation indicative of the levels of similarity, based on at least one selected from a group of characters preceding a predetermined numeric character string, the types of these characters, the number of these characters, subsequent characters, the types of these characters, the number of these characters, the number of the characters in said numeric character string and the numerical values in said numeric character string, among words stored in said words dictionary, and extracts a word whose calculated similarity is the highest as the similar word.

3. The pronunciation specifying apparatus of claim 1, wherein said rule creating means creates one or plural numerical pronunciation rules containing information regarding distinction between column reading and split column reading, language information and information regarding the pronunciation of each numerical character, based on the pronunciation stored in correlation to the extracted similar word.

4. The pronunciation specifying apparatus of claim 2, wherein said rule creating means creates one or plural numerical pronunciation rules containing information regarding distinction between column reading and split column reading, language information and information regarding the pronunciation of each numerical character, based on the pronunciation stored in correlation to the extracted similar word.

5. The pronunciation specifying apparatus of claim 1, further comprising numerical pronunciation rule storing means which stores, in memory means, said numerical pronunciation rules created by said rule creating means

6. The pronunciation specifying apparatus of claim 2, further comprising numerical pronunciation rule storing means which stores, in memory means, said numerical pronunciation rules created by said rule creating means.

7. The pronunciation specifying apparatus of claim 3, further comprising numerical pronunciation rule storing means which stores, in memory means, said numerical pronunciation rules created by said rule creating means.

8. The pronunciation specifying apparatus of claim 4, further comprising numerical pronunciation rule storing means which stores, in memory means, said numerical pronunciation rules created by said rule creating means.

9. The pronunciation specifying apparatus of claim 1, further comprising numerical character string pronunciation memory means which stores, in said words dictionary, the notation and the pronunciation of said numeric character string specified by said numeric character string pronunciation specifying means.

10. A pronunciation specifying apparatus which includes a words dictionary in which the notations and the pronunciations of plural words are stored, wherein the pronunciation of character string data containing a numeric character string is specified, comprising a processor capable of performing the operations of
accepting character string data containing a numeric character string;
extracting plural words which partially match said character string data thus accepted, from among the plural words stored in said words dictionary;
determining whether said numeric character string contained in said character string data thus accepted has a numeric character string portion for which a partially matching word can not be extracted;
extracting from said words dictionary similar words which are similar to said numeric character string portion for which a partially matching word can not be extracted, when it is determined that there is a numeric character string portion for which the extraction is found impossible;
specifying words constituting said character string data thus accepted, based on the plural words and the extracted similar word;
specifying the pronunciations of the extracted plural words among the specified words;
creating numerical pronunciation rules which are rules regarding the pronunciation of the numeric character string contained in the extracted similar word among the specified words;
specifying the pronunciation of said numeric character string contained in the similar word, based on said numerical pronunciation rules thus created; and
specifying the pronunciation of said character string data, based on the pronunciations of the specified words and based on the pronunciation of the similar word including the pronunciation of said numeric character string thus specified.

11. The pronunciation specifying apparatus of claim 10 comprising the processor further capable of performing the operations of
calculating similarities which are values of evaluation indicative of the levels of similarity, based on at least one selected from a group of characters preceding a predetermined numeric character string, the types of these characters, the number of these characters, subsequent characters, the types of these characters, the number of these characters, the number of the characters in said numeric character string and the numerical values in said numeric character string, among words stored in said words dictionary; and
extracting a word whose calculated similarity is the highest as the similar word.

12. The pronunciation specifying apparatus of claim 10 comprising the processor further capable of performing the operation of
creating one or plural numerical pronunciation rules containing information regarding distinction between column reading and split column reading, language information and information regarding the pronunciation of each numerical character, based on the pronunciation stored in correlation to the extracted similar word.

13. The pronunciation specifying apparatus of claim 11 comprising the processor further capable of performing the operation of
creating one or plural numerical pronunciation rules containing information regarding distinction between column reading and split column reading, language information and information regarding the pronunciation of each numerical character, based on the pronunciation stored in correlation to the extracted similar word.

14. The pronunciation specifying apparatus of claim 10 comprising the processor further capable of performing the operation of:
storing said numerical pronunciation rules thus created, in memory means.

15. The pronunciation specifying apparatus of claim 11 comprising the processor further capable of performing the operation of
storing said numerical pronunciation rules thus created, in memory means.

16. The pronunciation specifying apparatus of claim 12 comprising the processor further capable of performing the operation of
storing said numerical pronunciation rules thus created, in memory means.

17. The pronunciation specifying apparatus of claim 13 comprising the processor further capable of performing the operation of
storing said numerical pronunciation rules thus created, in memory means.

18. The pronunciation specifying apparatus of claim 10 comprising the processor further capable of performing the operation of
storing the notation and the pronunciation of said numeric character string thus specified, in said words dictionary.

19. A pronunciation specifying method of specifying the pronunciation of character string data containing a numeric character string, using a words dictionary in which the notations and the pronunciations of plural words are stored, comprising the steps of
accepting character string data containing a numeric character string;
extracting plural words which partially match said character string data thus accepted, from among the plural words stored in said words dictionary;
determining whether said numeric character string contained in said character string data thus accepted has a numeric character string portion for which a partially matching word can not be extracted;
extracting from said words dictionary a similar word which is similar to said numeric character string portion for which a partially matching word can not be extracted, when it is determined that there is a numeric character string portion for which the extraction is found impossible;
specifying words constituting said character string data thus accepted, based on the plural words and the extracted similar word;
specifying the pronunciations of the extracted plural words among the specified words;
creating numerical pronunciation rules which are rules regarding the pronunciation of the numeric character string contained in the extracted similar word among the specified words;
specifying the pronunciation of said numeric character string contained in the similar word, based on said numerical pronunciation rules thus created; and
specifying the pronunciation of said character string data, based on the pronunciations of the specified words and based on the pronunciation of the similar word including the pronunciation of said numeric character string thus specified.

20. A recording medium storing a computer program for a computer including a words dictionary in which the notations and the pronunciations of plural words are stored, which specifies the pronunciation of character string data containing a numeric character string,
wherein the computer program stored in said recording medium comprises the steps of
causing the computer to extract plural words which partially match said character string data thus accepted, from among the plural words stored in said words dictionary;
causing the computer to determine whether said numeric character string contained in said character string data thus accepted has a numeric character string portion for which a partially matching word can not be extracted;
causing the computer to extract from said words dictionary a similar word which is similar to said numeric character string portion for which a partially matching words can not be extracted, when it is determined that there is a numeric character string portion for which the extraction is found impossible;
causing the computer to specify words constituting said character string data thus accepted, based on the plural words and the extracted similar word;
causing the computer to specify the pronunciations of the extracted plural words among the specified words;
causing the computer to create numerical pronunciation rules which are rules regarding the pronunciation of the numeric character string contained in the extracted similar word among the specified words;
causing the computer to specify the pronunciation of said numeric character string contained in the similar word, based on said numerical pronunciation rules thus created; and
causing the computer to specify the pronunciation of said character string data, based on the pronunciations of the specified words and based on the pronunciation of the similar word including the pronunciation of said numeric character string thus specified.
